(19) United States
(12) Patent Application Publication
(10) Pub. No.: US 2013/0221971 A1
(43) Pub. Date: Aug. 29, 2013

(54) Electrode for Application in Electrochemical Measuring Systems

(71) Applicant: Endress + Hauser Conducta Gesellschaft fur Mess- und Regeltechnik mbH + Co. KG, (US)

(72) Inventors: Thomas Endl, Waldheim (DE); Wolfram Nowak, Schluchtern (DE); Thilo Trapp, Aliso Viejo, CA (US); Jens Voigtlander, Waldheim (DE)

(73) Assignee: Endress + Hauser Conducta Gesellschaft Fur Mess-und Regeltechnik mbH + Co. KG, Gerlingen (DE)

(21) Appl. No.: 13/760,563

(22) Filed: Feb. 6, 2013

(30) Foreign Application Priority Data
Feb. 8, 2012 (DE) 10 2012101 004.8

(51) Int. Cl. G01N 27/403

(52) U.S. Cl. CPC G01N 27/403
USPC 324/425

(57) ABSTRACT

An electrode for application in electrochemical measuring systems, comprising: at least one housing, in which at least one chamber is embodied, at least one electrolyte, which is arranged in the chamber, at least one potential forming element, which is arranged in the chamber in such a manner that the electrolyte wets the potential forming element, and at least one electrical conductor, which contacts the potential forming element and leads the potential from the chamber, characterized in that the electrical conductor is provided with at least one coating.

### TECHNICAL FIELD

The invention relates to an electrode for application in electrochemical measuring systems, for example, for determining an electrochemical potential.

### BACKGROUND DISCUSSION

Electrochemical sensors are used, for instance, to determine pH value and are widely applied, for example, in chemistry, medicine, industry, and environmental and water analysis. The problem area upon which the invention is based will be explained using potentiometric sensors. The invention is, however, not limited to potentiometric sensors, but, instead, relates generally to electrodes for application in electrochemical measuring systems, e.g. also electrodes for amperometric methods. Potentiometric sensors have a measuring electrode and a reference electrode, between which a potential difference is determined. Besides systems of measuring electrode and reference electrode, which are separately introduced into the process medium, especially in the field of pH measurement, also so called single-rod, measuring chains, also called combination electrodes, are known, which combine measuring electrode and reference electrode in one probe.

The measuring electrode has a wire shaped, potential sensing element, which is composed, as a rule, of a potential forming or potential sensitive element, most often, silver/silver chloride, and an electrical conductor in the form of a metal wire, for leading the potential off. The potential forming element is at least partially surrounded by a reference electrolyte. Via a liquid junction, e.g. a diaphragm, the reference solution is placed in electrochemical exchange with the measured medium.

The potential sensing element of the reference electrode can likewise be composed of silver/silver chloride as well as an electrical conductor and is, most often, immersed in an electrolyte solution. Potential sensing element and electrolyte solution are, as a rule, placed in a glass tube, which is terminated facing the medium to be measured with a pH-sensitive glass membrane. The potential between reference electrode and measuring electrode is dependent on the pH value of the measured medium.

In order that the electrical conductor not decompose in the solution, an electrochemical resistant material is necessary. Most often used here is a noble metal, such as silver or platinum.

Via a sealing element, for instance, in the form of an adhesive layer, the conductor is led to a corresponding interface on the end of the electrode away from the medium. Via the interface, the measurement signal reaches a superordinated system, for example, a measurement transmitter.

There are forms of embodiment with electrodes, which are more than 40 cm long. In such case, also the electrical conductor must be at least this long. In the application of silver or platinum, there are considerable material costs for the electrical conductors of solid material.

### SUMMARY OF THE INVENTION

An object of the invention is to provide an electrode for electrochemical measurements, which is cost effectively manufacturable and nevertheless electrochemically resistant.

The object is achieved by an electrode, comprising
at least one housing, in which at least one chamber is embodied,
at least one electrolyte, which is arranged in the chamber,
at least one potential forming element, which is arranged in the chamber in such a manner that the electrolyte wets the potential forming element, and
at least one electrical conductor, which contacts the potential forming element and leads the potential from the chamber, characterized in that the electrical conductor is provided with at least one coating.

If the electrical conductor is provided with a coating, it is no longer unavoidable that the electrical conductor be of a material, which is electrochemically resistant. The coating, in contrast, must be selected from the group of such materials. Thus, a price favorable material can be selected for the conductor, and only the coating need be a possibly expensive, electrochemically resistant material.

In an advantageous embodiment, the potential forming element at least partially jackets and terminates the electrical conductor. The coating of an entire conductor is a standard process. The potential forming element is applied on the coating at an end of the conductor. This end serves then for determining the potential.

In an alternative form of embodiment, the potential forming element is arranged axially relative to the electrical conductor and connected and/or contacted via a joint with the electrical conductor.

In a preferred embodiment, the potential forming element is composed of at least one metal or of at least one metal salt, or of a combination of at least one metal and at least one metal salt.

Advantageously, the coating is composed of a more noble material than the electrical conductor. In this way, the electrical conductor is protected against corrosion. In the ideal case, the coating is a noble metal or a noble metal alloy. Noble metals are very resistant against corrosion, especially against oxidation. By placing a noble metal layer as coating, the electrical conductor is protected. The noble metal layer is, in contrast to the conductor, a relatively thin layer, whereby costs can be saved.

As an alternative to noble metal or noble metal coatings, a number of other materials are likewise suitable, so long as they are (electro)chemically sufficiently resistant.

In a preferred embodiment, the coating is composed of glass, wherein, in the region of the potential forming element, the glass is omitted. Glass has similarly corrosion resistant properties as a noble metal and can be used preferably. In order that an electrical contact between potential forming element and electrical conductor exist, the glass is omitted from this region. The glass coated wire can be led through the sealing element.

In an advantageous further development, the electrical conductor is composed of a base metal or an alloy of a base metal. Costs can be saved in this way, since base metals and their alloys are, as a rule, less expensive than noble metals.

Preferably, the electrical conductor is provided with a first coating and a second coating, wherein the electrical conductor is less noble than the first coating, and the second coating is glass, wherein, in the region of the potential forming element, the glass is omitted. By applying two coatings on the electrical conductor, one obtains additional assurance that the electrical conductor will not be attacked by corrosion. Besides glass, also other corrosion resistant materials are options.

In a preferred embodiment, the electrical conductor is composed of titanium or a titanium alloy and the coating is a platinum metal, especially platinum itself. In the case of a conductor with two coatings, the first coating is composed of a platinum metal, especially platinum itself, and the second coating is composed of glass. Preferably, the thermal expansion coefficient of the glass is selected to be similar to that of titanium.

In a preferred embodiment, the electrical conductor is composed of tungsten or a tungsten alloy and the coating is composed of a platinum metal, especially platinum itself. In the case of a conductor with two coatings, the first coating is composed of a platinum metal, especially platinum itself, and the second coating is composed of glass. Preferably, the thermal expansion coefficient of the glass is selected to be similar to that of titanium.

### BRIEF DESCRIPTION OF THE DRAWINGS

The invention will now be explained in greater detail based on the appended drawing, the figures of which show as follows:

FIG. 1 is a schematic illustration of a reference electrode;

FIGS. 2a and 2b are a first embodiment of an electrical conductor with potential forming element;

FIG. 3 is a second embodiment of an electrical conductor with potential forming element;

FIG. 4 is a third embodiment of an electrical conductor with potential forming element; and

FIGS. 5a and 5b are a fourth embodiment of an electrical conductor with potential forming element.

### DETAILED DESCRIPTION IN CONJUNCTION WITH THE DRAWINGS

In the figures, equal features are provided with equal reference characters.

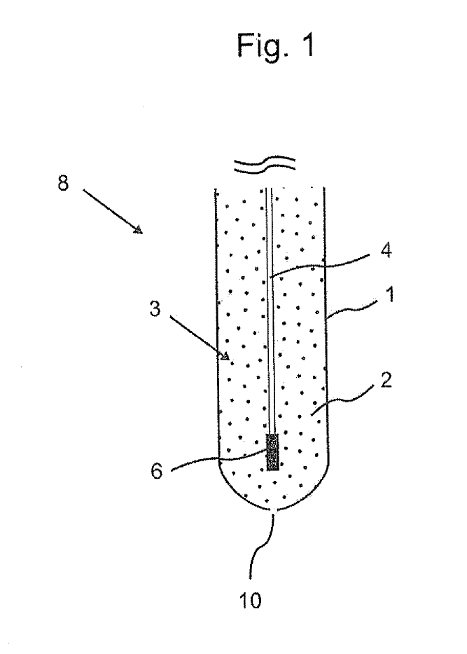

FIG. 1 shows schematically the construction of an electrode 8, more exactly a reference electrode 8, embodied according to the invention. Electrode 8 is placed in a medium, whose pH-value is to be determined. The invention can, however, equally be applied in the case of other electrodes, for example, in an ion-selective, measuring electrode, such as, for example, a pH-measuring electrode, as well as in sensors for measuring redox potential.

The reference electrode includes a housing 1, which is preferably composed of glass and which is filled, at least partially, with an electrolyte 3. For sealing the upper housing section to retain the electrolyte 3, a closure element (not shown) is placed in the housing. The part of the housing bounded by the closure element is referred to in the following as chamber 2. Located in chamber 2 is a potential forming element 6. For leading the potential, which forms on the potential forming element 6, off, the latter is contacted with an electrical conductor 4.

The here described method of pH-measuring is a potentiometric method, i.e., as a rule, there is no electrical current flow through the electrical conductor 4. The invention can, however, also be applied to electrochemical methods, in the case of which an electrical current flow does take place, thus e.g, in the case of amperometry or coulometry.

Electrolyte 3 wets the potential forming element 6. In the case of the illustrated reference electrode, there is located in the wall of the chamber 2 a liquid junction 10 (not described in greater detail), which forms the salt bridge to the medium.

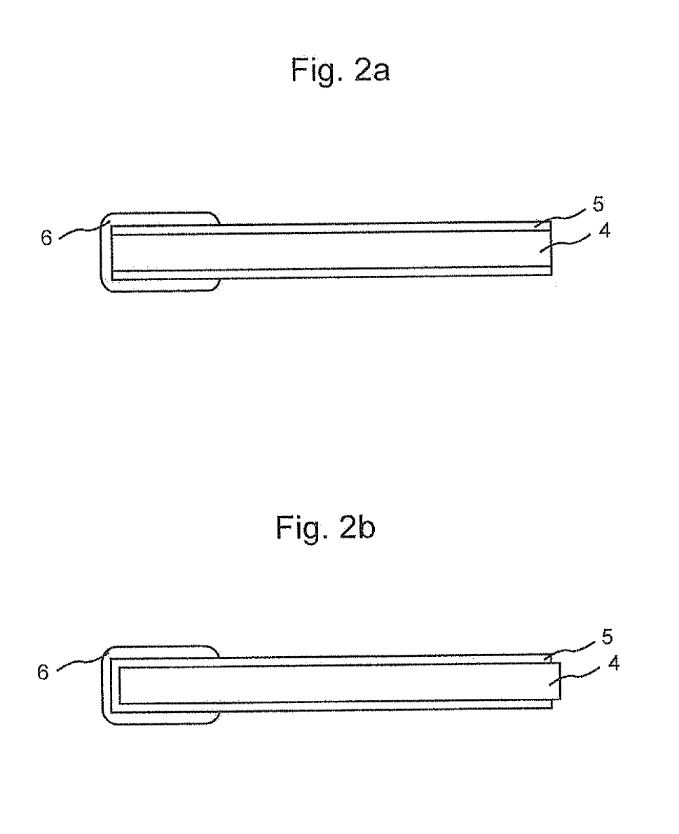

FIG. 2 shows such an electrical conductor 4 in detail. The conductor is typically embodied as a wire. Forms of embodiment can include, however, also stranded, or litz, wire. Electrical conductor 4 is surrounded over its complete length by a coating 5. In an embodiment, also both ends of the conductor are coated. The electrical conductor 4 is composed typically of a more base material than the coating 5. Materials for the conductor can include, for example, titanium, tungsten, osmium, zirconium, hafnium, niobium, vanadium, aluminum, molybdenum, copper or one of their alloys, such as e.g. TiAl₆Sn₂Zr₄Mo₂. Material for coating 5 includes, for example, a platinum metal (ruthenium, rhodium, palladium, osmium, iridium, platinum), silver or gold. Coating 5 is applied by electrical currentless or electrical current, coating technologies.

Usually, the material of the coating is a noble metal. Since noble metals are very corrosion resistant, the electrical conductor 4 is protected from the electrolyte 3 by the coating 5. Since only a thin coating thickness of the coating 5 is required, material costs can be saved. FIG. 2b shows a form of embodiment, in the case of which the coating 5 is applied also on the end of the conductor 4, while, in contrast, in FIG. 2a the end is free of the coating 5.

Located on the end of the electrical conductor 4 in the medium is the potential forming element 6. In a first embodiment, the potential forming element 6 jackets the conductor and surrounds its end in the medium, in order to protect the more base metal from the electrolyte 3 so as to avoid corrosion, most often, oxidation, of the more base metal.

The potential forming element 6 is composed of a metal part and a supply of a salt of the metal. For example, the metal part is silver and the salt, silver chloride. Metal and metal salt are not shown here as two separate layers. Such is, however, known, for example, from EP 1 172 648 A1. The metal coating is applied by a chemical, electrochemical or physical process. The salt is preferably applied by a chemical or electrochemical process.

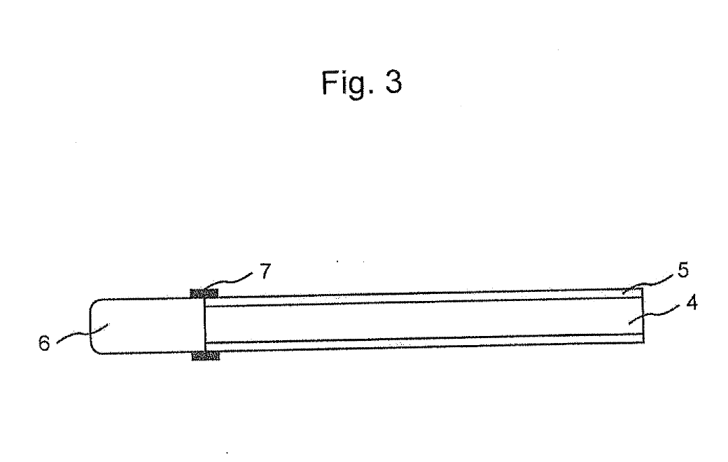

FIG. 3 shows another embodiment of the electrode 8 of the invention. In such case, the potential forming element 6 is attached axially to the electrical conductor 4. The potential forming element 6 is connected with the electrical conductor 4, in such case, for example, by welding, soldering, brazing or adhering at a joint 7. At the joint 7, for additional safety, a layer of a noble material, typically the same as for coating 5, can be applied. The electrical conductor 4 with its coating 5 has the same properties as described above with reference to FIGS. 1 and 2.

There are variants, in the case of which a protective lacquer or a shrink tube serve as coating or joint.

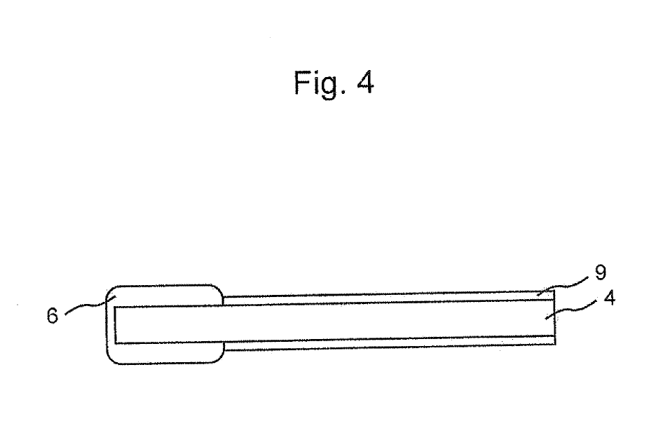

FIG. 4 shows another embodiment of the electrode 8 of the invention. Here, the electrode carries a coating 9 of glass, wherein, on an end of the electrode 8, the glass is omitted and the potential forming element 6 applied as above described. The glass is applied, for example, by melting a glass tube on the metal wire.

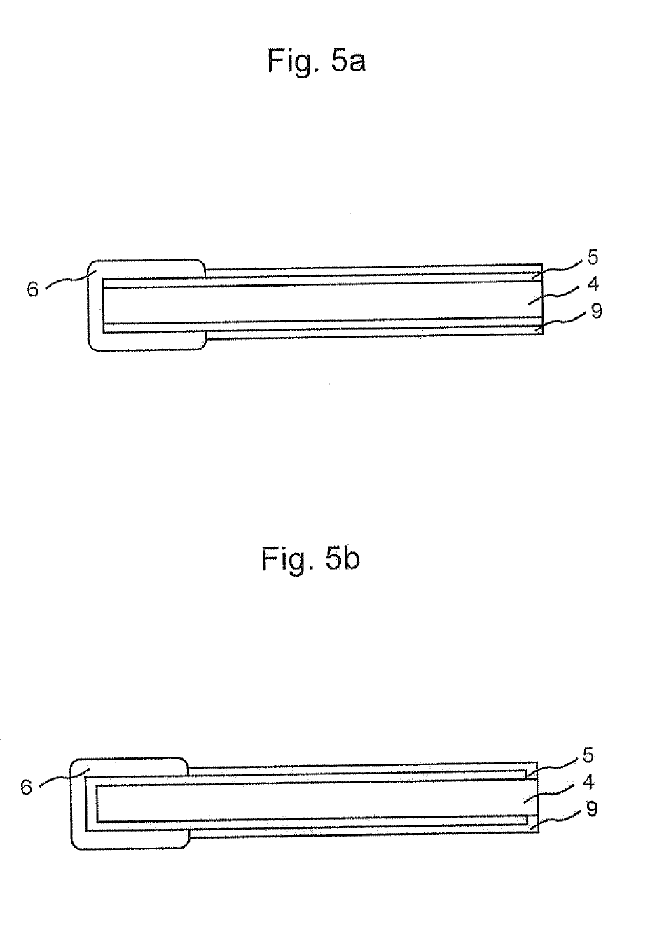

FIG. 5 shows another embodiment of the electrode 8 of the invention. In such case, two coatings 5, 9 are applied on the electrical conductor 4. The first coating 5 is, in such case, a more noble material than that of the electrical conductor 4. The second coating 9 is a glass and offers additional safety against corrosion. The first and second coatings 5, 9 are applied as above described using the materials as above described. FIG. 5b shows a form of embodiment, in the case of which the coating 5 is applied also on the end of the conductor 4, while, in contrast, in FIG. 5a, coating 5 is omitted on the end.

Also a combination of the forms of embodiment of FIG. 2 and FIG. 5 is an option, i.e. a system of two coatings and an axial arrangement of the potential forming element 6.

Furthermore, a combination of the forms of embodiment of FIGS. 4 and 5 is another option, i.e. a coating of glass and an axial arrangement of the potential forming element 6.

1-11. (canceled)

12. An electrode for application in electrochemical measuring systems, comprising:
at least one housing, in which at least one chamber is embodied;
at least one electrolyte, which is arranged in said chamber;
at least one potential forming element, which is arranged in said chamber in such a manner that said electrolyte wets said at least one potential forming element; and
at least one electrical conductor, which contacts said at least one potential forming element and leads the potential from said chamber, wherein:
said at least one electrical conductor is provided with at least one coating.

13. The electrode as claimed in claim 12, wherein:
said at least one potential forming element at least partially jackets and terminates said at least one electrical conductor.

14. The electrode as claimed in claim 12, wherein:
said at least one potential forming element is arranged axially relative to said at least one electrical conductor and is connected and/or contacted via a joint with said at least one electrical conductor.

15. The electrode as claimed in claim 12, wherein:
said at least one potential forming element comprises at least one metal or at least one metal salt, or a combination of at least one metal and at least one metal salt.

16. The electrode as claimed in claim 12, wherein:
said coating comprises a more noble material than said at least one electrical conductor.

17. The electrode as claimed in claim 12, wherein:
said coating is a noble metal or a noble metal alloy.

18. The electrode as claimed in claim 12, wherein:
said coating comprises glass; wherein:
in the region of said at least one potential forming element, glass is omitted.

19. The electrode as claimed in claim 12, wherein:
said at least one electrical conductor comprises a base metal or an alloy of a base metal.

20. The electrode as claimed in claim 12, wherein:
said at least one electrical conductor is provided with a first coating and a second coating;
said at least one electrical conductor is less noble than said first coating, and said second coating is glass; and
in the region of said at least one potential forming element, the glass is omitted.

21. The electrode as claimed in claim 12, wherein:
said at least one electrical conductor comprises titanium or a titanium alloy and said coating is a platinum metal, especially platinum itself.

22. The electrode as claimed in claim 12, wherein:
said at least one electrical conductor comprises tungsten or a tungsten alloy and said coating is a platinum metal, especially platinum itself.
